(19) United States
(12) Patent Application Publication
(10) Pub. No.: US 2003/0184506 A1
(43) Pub. Date: Oct. 2, 2003

(54) Current modulation method for liquid crystal display projection lamp

(75) Inventors: Peter J. Janssen, Scarborough, NY (US); Douglas A. Stanton, Ossining, NY (US)

Correspondence Address: PHILIPS INTELLECTUAL PROPERTY & STANDARDS, P.O. BOX 3001, BRIARCLIFF MANOR, NY, 10510, US

(73) Assignee: Koninklijke Philips Electronics N.V.

(21) Appl. No.: 10/114,497

(22) Filed: Apr. 2, 2002

(51) Int. Cl. G09G 3/36

(52) U.S. Cl. 345/87

(57) ABSTRACT

A method of reducing the artifact in color sequential LCD projection systems while providing flicker free and stable lamp operation. The method consists of establishing the frequency of lamp pulsing at a rate in response to the display frame rate. A further refinement is achieved by alternating a sequence of intervals of enhanced brightness with a sequence of low lamp current levels in successive frames to minimize spatial modulation.

### TECHNICAL FIELD

This invention relates generally to a method for the control of a pulsed drive for arc lamps, and, more particularly, to a scrolling, color compatible, current modulation method for application to the projection lamps used in liquid crystal display (LCD) systems.

### BACKGROUND TECHNOLOGY

Pulsed drive is necessary for flicker free operation and long term stability of arc lamps, such as ultra-high pressure (UHP) lamps, commonly used in LCD color projection systems. However, presently known pulsed drive schemes create artifacts in a color sequential system. Consequently, in order to avoid the creation of these artifacts, it has been necessary to accept flicker and shorter lamp life in color sequential LCD projection systems.

The present invention is directed to overcoming one or more of the problems or disadvantages associated with the relevant technology.

### SUMMARY OF THE INVENTION

In the simplest form of the preferred embodiment of this invention the frequency of the projection lamp current pulses is increased to three times the display frame rate. The resulting, stationary stripe patterns are thereby color balanced as a result of each area being exposed to the same alternating red, green and blue light flashes. In a further refinement, this sequence of light pulses (intervals of enhanced brightness) is alternated with a complementary sequence of decreased brightness (dimming the lamp to a low, “keep alive” current level).

The pulsed drive method of the present invention reduces or eliminates such artifacts, enabling essentially flicker free and stable lamp operation in a color sequential system.

### BRIEF DESCRIPTION OF THE DRAWINGS

In the accompanying drawings, like reference numerals indicate corresponding parts throughout.

FIG. 1 is a diagram illustrating a drive scheme and associated light modulation associated with the background technology;

FIG. 2 is a diagram illustrating operation of the drive method of the present invention in simplified form;

FIG. 3 is a diagram illustrating the effect of strobing in areas where the LC is in transition or not illuminated;

FIG. 4 is a diagram illustrating an embodiment of the invention wherein the lamp drive scheme leaves no artifacts;

FIG. 5 is a Brightness vs Time diagram illustrating operation of the preferred embodiments of the invention for a two-frame periodicity;

FIG. 6 is a Brightness vs Time diagram illustrating operation of embodiments of the invention utilizing a three-frame period with two pulses per frame; and

FIG. 7 is a Brightness vs Time diagram illustrating operation of embodiments of the utilizing a six-frame periodicity with one pulse per frame.

### BEST MODE FOR CARRYING OUT THE INVENTION

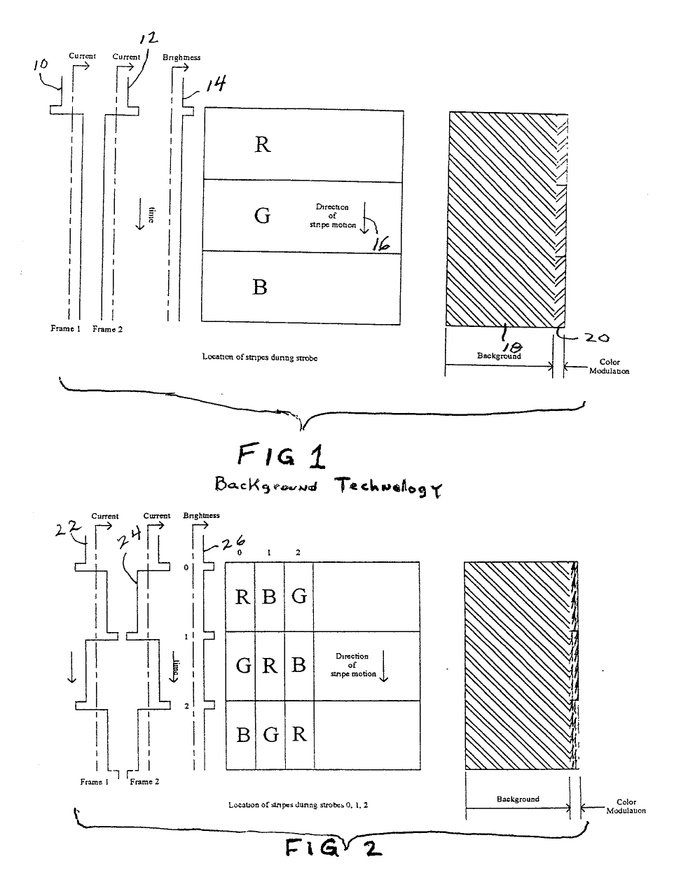

Referring now to the drawings, the following is a description of a preferred embodiment of the invention wherein in FIG. 1 there is illustrated a present lamp drive method and associated light modulation. As is known to those skilled in the art, strobed light is frame synchronized to a scrolling stripe pattern of a color sequential LCD system. The lamp current is illustrated with respect to time, by plots 10 and 12 for successive display frames. As illustrated, the current is pulsed (doubled @8% duty cycle) just before polarity inversion at the beginning of each frame. The lamp brightness during this time is indicated by plot 14. The location of Red, Green and Blue (R,G and B)stripes during strobing is indicated by blocks R, G and B, corresponding to these colors respectively, and the direction of stripe motion is indicated by arrow 16.

The foregoing example illustrates a uniform grey background 18, and the pulsed illumination causes a strobed color stripe pattern 20 (8% color modulation depth) superimposed on the “normal” image, as perceived in the absence of a pulse. Driving the arc lamp asynchronously can cause low frequency beat patterns to which the human peripheral vision is notoriously sensitive. However, it is not sufficient to merely synchronize the pulsed illumination to the display frame frequency as such synchronization would result in all strobed images adding up to one large, static stripe pattern. Accordingly, in the present invention it has been found that increasing pulsation of the lamp drive in relation to the display frame rate will color balance stripe patterns as each area is exposed to the same, alternating R, G and B light flashes.

The drive scheme of the present invention is shown in simplified form of a preferred embodiment in FIG. 2, a diagram showing the same current and brightness operational parameters as illustrated in FIG. 1. That is, plots 22 and 24 indicate lamp current with respect to time for successive frames of the display system. The increased frequency of lamp pulsing, preferably, three times per display frame, provides the resultant lamp brightness indicated by plot 26. Location of the stripes during strobes 0, 1 and 2 of each display frame are indicated in the blocks lettered R,G and B. This drive method results in an overlay of three, phase-shifted patterns, effectively eliminating colored bands. The stationary stripes patterns are now color balanced as each area is exposed to the same, alternating R,G and B light flashes.

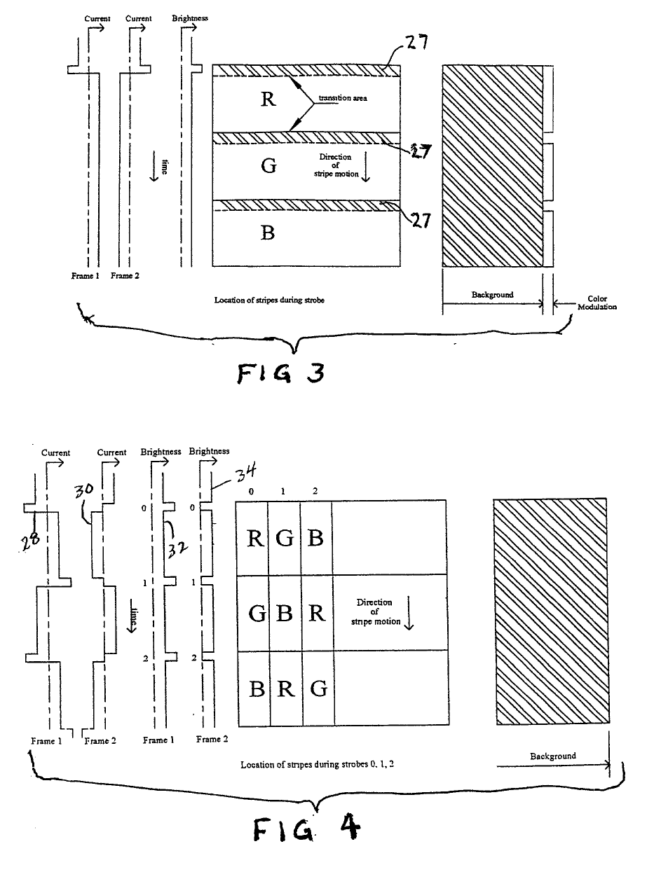

The diagram of FIG. 3 shows the effect of strobing in areas where the liquid crystal is in transition (e.g., due to black pre-write) or not illuminated (e.g., in the dark guard bands separating the color stripes) indicated by a reference numeral 27. As those parts of the display are inactive during a strobe, there is no contribution to excess color from strobing.

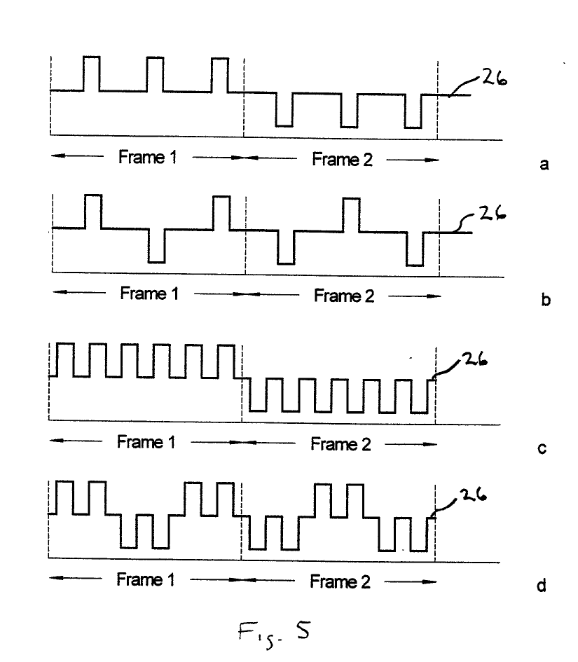

While the use of three pulses per frame is preferable, as described with reference to FIGS. 2 and 4, these three pulses may be positive or negative as illustrated in FIG. 5. FIG. 5 illustrates four additional variations of the preferred three-pulse embodiments. Each of the embodiments is illustrated for a two-frame periodicity and discloses the use of variations of three positive and negative pulses per frame, as illustrated in FIGS. 5a-5d.

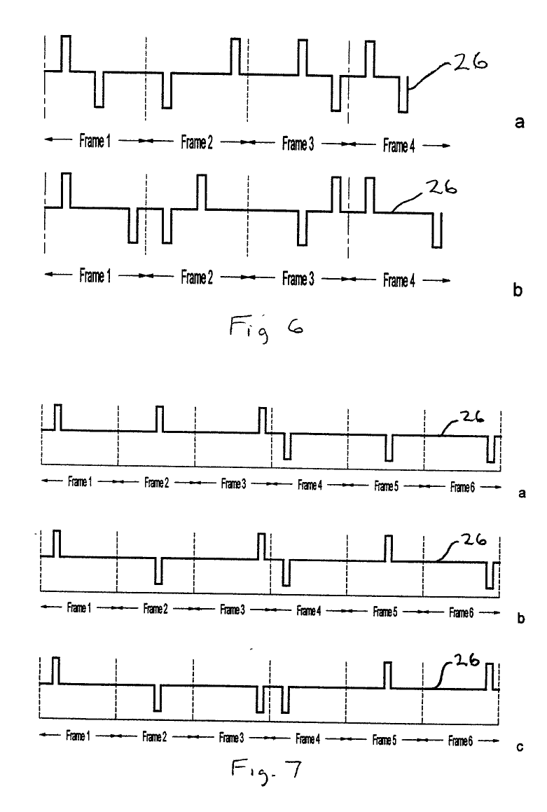

FIGS. 6 and 7 illustrate alternative embodiments of the method of this invention utilizing a three frame period with two pulses (positive or negative) per frame, as illustrated in FIGS. 6a 6b, and a six frame periodicity with one stepped pulse (positive or negative) per frame as illustrated in FIGS. 7A, 7b and 7c.

The preferred method of this invention as illustrated in FIG. 2 and FIG. 5 causes a spatial brightness variation. This variation can be eliminated by the method depicted in FIG. 4 which illustrates a lamp drive method leaving no artifacts. The lamp drive current for successive frames is indicated by plots 28 and 30, synchronized at three pulses or strobes (0, 1, 2) per display frame. Lamp brightness corresponding to the current levels of plots 28 and 30 is indicated by plots 32 and 34, respectively. In this manner the pulses for one display frame (32) provide intervals of enhanced brightness, whereas the sequence of pulses for the next display frame 34 result in dimming the lamp to a low, “keep alive” current level. Accordingly, except for high frequency flicker, the light modulation will have no effect, even on those parts in the display that are in transition or otherwise inactive (e.g., the dark bands separating the color stripes) during the strobe or flash. The result is absence of spatial modulation over the entire display area.

### FUNCTIONAL DESCRIPTION

In the preferred embodiment of the improved drive system of the invention the synchronized lamp frequency is increased to three times the display frame rate. The resulting, stationary stripe patterns are color balanced as each area is exposed to the same, alternating, R, G and B light flashes. FIG. 3 illustrates the effect of strobing in areas where the liquid crystal is in transition, e.g., due to black pre-write or not illuminated, as in the dark guard bands separating the color stripes. As those parts of the display are inactive during a strobe, there is no contribution to excess color from strobing.

The method illustrated by FIG. 2 and FIG. 5 causes a spatial brightness variation which can be overcome by the method illustrated by FIG. 4 wherein there is utilized a sequence of light pulses (intervals of enhanced brightness) with a complementary sequence of low level illumination (intervals wherein the lamp is dimmed to a low current level). The light modulation will then have no effect, even on those parts in the display that are in transition or otherwise inactive during the flash. Such complementary sequences of low level illumination may also be incorporated into the embodiments illustrated with reference to FIGS. 6 and 7.

While these examples of lamp pulsing are illustrated, it is to be understood that it is believed that burst modes may be utilized. In this manner one of the sequences will be applied for a number of cycles with possibly long intervals of no pulsing occurring or being necessary to obtain the desired objective.

Other aspects and features of the present invention can be obtained from a study of the drawings, the disclosure, and the appended claims.

1. A method of reducing or eliminating the artifacts created by pulsed drive in a color sequential LCD projection system using an arc lamp wherein the projection lamp drive is frame synchronized to the display frame rate, said method comprising:
establishing a frequency of said lamp pulses exceeding the display frame rate so that each display frame is exposed to the same alternating red, green and blue enhanced brightness light flashes.

2. The method of claim 1 wherein said lamp pulses are alternated between said alternating red, green and blue light flash sequences of enhanced brightness and a complementary sequence of light pulses dimming said lamp to a lower current level between successive display frames.

3. The method of claim 1 wherein said frequency of lamp pulses occur intermittently.

4. The method of claim 2 wherein said alternating red, green and blue light flash sequences of enhanced brightness occur intermittently.

5. A method of reducing or eliminating the color artifacts created by a pulsed lamp drive in a color sequential LCD projection system using a projection lamp wherein the projection lamp drive is frame synchronized to the display frame rate, said method comprising:
pulsing said projection lamp at a rate exceeding said display frame rate thereby exposing each said display frame to alternating flashes of each primary color.

6. The method of claim 5 wherein said projection lamp is pulsed at a rate at least three times per display frame exposing each said display frame to alternating flashes of each primary color.

7. The method of claim 6 wherein said alternating flashes of primary color are alternated with a complementary sequence of pulses dimming said projection lamp to a low “keep alive” current level between successive display frames.

8. The method of claim 5 wherein said frequency of said lamp pulses occurs at a rate of two pulses per display frame and for a three display frame period.

9. The method of claim 5 wherein said lamp pulses can occur as positive or negative pulses.

10. The method of claim 5 wherein said projection lamp is pulsed at a rate of at least two times per display frame and said projection lamp pulses are sequentially stepped for each sequential display frame to alternate flashes of each primary color for a period of three display frames.

11. A method of reducing or eliminating the color artifacts created by a pulsed lamp drive in a color sequential LCD projection system using a projection lamp wherein the projection lamp drive is frame synchronized to the display frame rate, said method comprising:
pulsing said projection lamp at a rate substantially equal to the display frame rate thereby exposing each said display frame to alternating flashes of each primary color, and sequentially stepping said pulsing of said projection lamp for each sequential display frame to alternate flashes of each primary color for a period of six display frames.
